(19) United States
(12) Patent Application Publication
(10) Pub. No.: US 2014/0095212 A1
(43) Pub. Date: Apr. 3, 2014

(54) SYSTEMS AND METHODS FOR PROVIDING QUALITY OF SERVICE FOR DATA SUPPORTING A DRIVING PERFORMANCE PRODUCT

(71) Applicants: Terje Gloerstad, Scottsdale, AZ (US); Kevin West, Phoenix, AZ (US); Paul Rice, Mesa, AZ (US)

(72) Inventors: Terje Gloerstad, Scottsdale, AZ (US); Kevin West, Phoenix, AZ (US); Paul Rice, Mesa, AZ (US)

(21) Appl. No.: 13/839,681

(22) Filed: Mar. 15, 2013

Related U.S. Application Data
(60) Provisional application No. 61/744,755, filed on Oct. 3, 2012.

(51) Int. Cl. G06Q 40/08

(52) U.S. Cl. CPC G06Q 40/08
USPC 705/4

(57) ABSTRACT

Quality of Service (QOS) systems and methods to determine the likelihood that a packet of information transmitted by an OBD, mobile, or other telematics device meets user requirements for accuracy, reliability, and quality of data suitable for a driving performance product, such as, for example, the implementation and modification of a usage based insurance (UBI) or behavior based insurance (BBI) or self-insurance program. Methods are established for determining when and how to display data to each constituent, including policyholders, insurance actuaries, and insurance carrier customer service staff. The QOS data may also be provided to OEM and GPS device manufacturers for the purpose of improving the performance of their software and devices. The QOS system analyzes the amount of time it takes to send and receive a packet of information, the performance of the GPS module and satellites, the presence or absence of data that is based on set conditions, performance metrics relative to key UBI or BBI variables, and self-tests on GPS or OEM hardware.

### CROSS REFERENCE TO RELATED APPLICATIONS

This application claims priority to, and the benefits of, U.S. provisional application Ser. No. 61/744,755 filed on Oct. 3, 2012, which is incorporated by reference herein in full.

### BACKGROUND

Providing usage-based insurance, other insurance products, and/or fleet management can include capturing data associated with driving performance (e.g., driving activity or “usage”), which, in some cases, may also be relevant to a particular insurance policy. Because decisions may be based on that data, for example, restatements of price, it is important to ensure the integrity and/or quality of the data, for example, for both policy holders and providers.

The following patent applications are incorporated by reference herein in full: U.S. provisional application Ser. No. 61/749,600, U.S. provisional application Ser. No. 61/762,547, U.S. application Ser. No. 13/835,381, and U.S. application Ser. No. 13/837,955.

### SUMMARY

In one embodiment, a method of determining data quality for data associated with driving performance, including receiving data associated with driving performance, comparing the data to a quality standard, determining if the data meets the quality standard, and selectively reporting the data to at least one data user based on whether the data meets the quality standard.

The descriptions of the invention do not limit the words used in the claims in any way or the scope of the claims or invention. The words used in the claims have all of their full ordinary meanings.

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify embodiments of this invention.

FIG. 1 is a block diagram showing an exemplary insurance platform;

FIG. 2 is a block diagram showing an exemplary QOS framework;

FIG. 3 is a block diagram showing another exemplary QOS framework with exemplary data users;

FIG. 4 is a block diagram showing another exemplary QOS framework with exemplary data status;

FIG. 5 is a flowchart showing the steps of an exemplary QOS process;

FIG. 6 is an exploded block diagram/flowchart of exemplary steps that may be included in the exemplary QOS process of FIG. 5;

FIG. 7 is a screenshot of a table showing exemplary QOS quality factors, standards, attributes, associated flags, etc. for evaluating HistoricalReading data;

FIG. 8 is a screenshot of a table showing exemplary QOS quality factors, standards, attributes, associated flags, etc. for evaluating HistoricalTrip data;

FIG. 9 is a screenshot of an exemplary home page of an exemplary QOS dashboard;

FIG. 10 is a screenshot of an exemplary view of an exemplary QOS dashboard showing one device;

FIG. 11 is a screenshot of an exemplary view of an exemplary QOS dashboard showing the underlying detail for OBD data about engine performance;

FIGURE is a screenshot of an exemplary view of an exemplary QOS dashboard showing missing trips details;

FIG. 13 is a screenshot of an exemplary view of an exemplary QOS application showing Display_Hide detail;

FIG. 14 is a screenshot of an exemplary view of an exemplary QOS dashboard showing the device interruption detail;

FIG. 15 is a screenshot of an exemplary view of an exemplary QOS application showing a scatter diagram that plots the number of satellites and the HDOP for two device vendors;

FIG. 16 shows exemplary communication protocols and exemplary devices containing the exemplary QOS engine and/or executing the exemplary QOS process.

### DESCRIPTION

The following includes definitions of exemplary terms used throughout the disclosure. Both singular and plural forms of all terms fall within each meaning:

“Address”, as used herein, includes but is not limited to one or more e-mail addresses, a distribution list including one or more e-mail addresses, uniform resource locator (URL) and file transfer protocol (FTP) locations or the like, network drive locations, a postal address, a combination of an e-mail address and a postal address, or other types of addresses that can identify a desired destination.

“Computer Readable Medium”, as used herein, includes but is not limited to any memory device, storage device, compact disc, floppy disk, or any other medium capable of storing data temporarily and/or permanently that can be interpreted by a computer.

“Device”, as used herein, includes any machine or component that attaches to and/or communicates with a computing device. Examples of peripheral devices, which are separate from a main computing device, include disk drives, printers, mice, and modems. Examples of integrated peripherals, which are incorporated into a main computing device, include central processing units and application specific integrated circuits. Most devices, whether peripheral or not, require a program called a device driver that acts as a translator, converting general commands from an application into specific commands that the device understands. The telematics device (104) is an exemplary device.

“Internet”, as used herein, includes a wide area data communications network, typically accessible by any user having appropriate software.

“Intranet”, as used herein, includes a data communications network similar to an internet but typically having access restricted to a specific group of individuals, organizations, or computers.

“Logic”, synonymous with “circuit” as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other logic device. Logic may also be fully embodied as software.

“Network”, as used herein, includes but is not limited to the Internet, intranets, Wide Area Networks (WANs), Local Area Networks (LANs), and transducer links such as those using Modulator-Demodulators (modems).

“Platform”, as used herein, includes but is not limited to a computing system that combines hardware and software, including application frameworks. The platform may include a computer architecture, operating system, programming languages, and related user interfaces, including run-time system libraries and/or graphical user interfaces. Providing a “platform as a service” (PaaS) is a category of computing services that may provide an integrated platform with specific application solutions as a service, with various levels of scalability. Services may include providing specialized and/or customized hardware, such as, for example, networks, servers, storage, interface devices, etc., and software, such as, for example, applications, interfaces, security, etc. Hardware and/or software associated with the services may or may not be dedicated to one platform. Providing a PaaS may include development, testing, deployment, hosting, maintenance, updating, etc. A PaaS may include the capability to integrate with various outside and/or private systems, such as, for example, web services, databases, and networks, utilizing, for example, Simple Object Access Protocol (SOAP) and Representational State Transfer (REST) interfaces.

“Signal”, as used herein, includes but is not limited to one or more electrical signals, analog or digital signals, one or more instructions, a bit or bit stream, or the like. The term “command” is synonymous with “signal.”

“Software”, as used herein, includes but is not limited to one or more computer executable instructions, routines, algorithms, modules or programs including separate applications or code from dynamically linked libraries for performing functions and actions as described herein. Software may also be implemented in various forms such as a stand-alone program, a servlet, an applet, instructions stored in a memory, part of an operating system (OS) or other type of executable instructions. It will be appreciated by one of ordinary skill in the art that the form of software is dependent on, for example, requirements of a desired application, the environment it runs on, and/or the desires of a designer/programmer or the like.

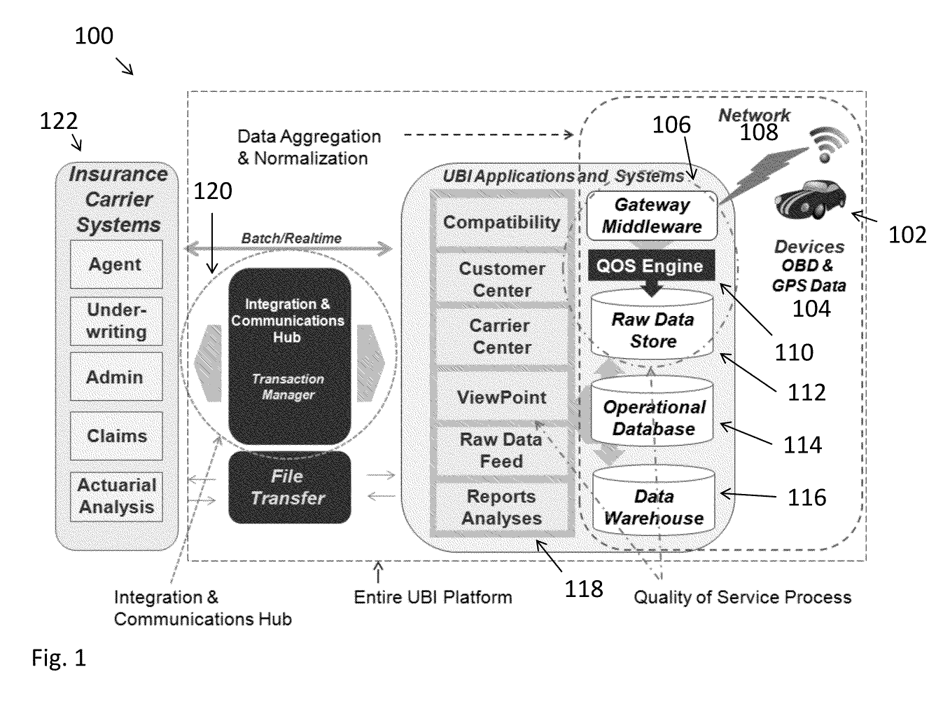

FIG. 1 shows an exemplary insurance support/enhancement platform 100, including exemplary hardware and software elements supporting carriers providing insurance, including, for example, usage-based insurance (UBI). As used herein, UBI includes usage-based insurance, behavior-based insurance (BBI), and other incentive or discount based insurance programs that may include use and behavior based elements including, for example, mileage, trips, driving performance and habits, geospatial data, etc. In other embodiments, the platform 100 may be associated with a driving performance product applicable to commercial/fleet management and self insurers.

Insurers, for example, may be property/casualty insurance carriers that may use a driving performance product, such as a UBI product, for personal lines of insurance or commercial lines of insurance. Self-insurers, for example, may be companies with a large fleet that may self-insure an underlying layer of risk and may buy an umbrella layer of coverage over the self-insured layer. Self-insurers may use a driving performance product, such as a UBI product, that will allow them to gather the same data on drivers that an insurer tracks. Fleet managers, for example, may be companies with fleets of commercial vehicles and may have commercial insurance with a company that may not offer UBI, but they may be eligible for a discount from their insurance carrier if they employ a driving performance product, such as a UBI product, to monitor their drivers' performance. In other situations, fleet managers may use a driving performance product, such as a fleet management product (e.g., a subset of a UBI product), with features that allow them to track location, fuel consumption, hours of vehicle operation, etc.

A UBI product is an exemplary driving performance product. For simplicity, this application may refer to exemplary UBI products, programs, systems, features, transactions, etc. However, references to UBI is exemplary and includes all of the exemplary driving performance products described above, among others.

In the exemplary platform 100 of FIG. 1, data, such as, for example, latitude/longitude of a vehicle 102 is captured and/or transmitted, for example, wirelessly from a device 104, associated with the vehicle 102, such as a dongle device, on-board diagnostic (OBD) device, global positioning system (GPS) device, iOS or Android device, smart phone, tablet, or other telematics device to one or more gateways 106 via, for example, network 108. The data from the device 104 may include information associated with driving performance related to, for example, a UBI product, such as, for example, driving behavior, vehicle location, etc. In some embodiments, data captured and/or transmitted by the device 104 may include data from more than one data source or device. For example, the device 104 may transmit data captured from the vehicle 102 OBD device and/or data captured from a GPS system included in the device 104. Gateways 106 may include a device 104 manufacturer's or provider's gateway or a common gateway established for the platform 100. In some embodiments, data may be captured and/or transmitted directly from the vehicle 102, such that the vehicle 102 or a component of the vehicle 102 is the device 104. The device 104 may or may not be connected to the vehicle 102. Data aggregation and normalization can occur using, for example, systems and methods described in U.S. provisional patent application Ser. No. 61/744,755, filed Oct. 3, 2012, and incorporated herein by reference in full.

Data may be processed through a Quality of Service (QOS) application or engine 110, which can evaluate, for example, data packets and aggregated packets (e.g., trips) and can pass results through algorithms for data retention, display, and/or use. Resulting raw data can be stored in raw data store 112 and passed to an operational database 114 and data warehouse 116, which may allow some applications 118 (e.g., Carrier Center, Customer Center, ViewPoint, etc.) to access the data directly and/or other applications (e.g., Actuarial Analysis) to access the data via, for example, File Transfer Protocol (FTP). An integration and communications hub 120 can manage transactions to and from other systems and applications, including, for example, the exemplary insurance carrier systems 122. These communications and transactions may include, for example, logistics for ordering the device 104, dashboards for viewing driving results as recorded by the device 104, processes for managing insurance rates, etc.

QOS engine 110 may be designed to meet the requirements of various users, including, for example, property/casualty insurers, self-insurers, and/or fleet managers that need to assess the accuracy, reliability, and quality of data used for design and implementation of, for example, UBI price adjustments, programs, and/or other products. The QOS engine 110 has several other uses, including, for example, use by device vendors and original equipment manufacturers (OEMs). The QOS engine may include standards for determining when and how to display data within various applications 118 and insurance carrier systems 122, such as, for example, the Carrier Center, the Customer Center, and Actuarial Analysis.

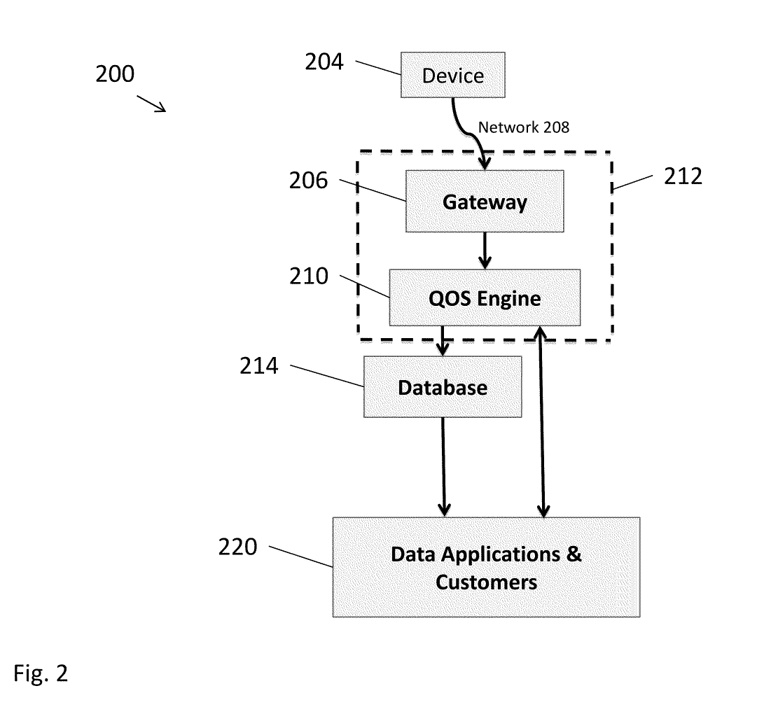

FIG. 2 shows an exemplary QOS framework 200. In this exemplary framework 200, with continued reference to certain elements of FIG. 1, data associated with a vehicle 102 may be captured and/or transmitted from a device 204 (e.g., device 104), to one or more gateways 206 (e.g., gateways 106) via, for example, network 208 (e.g., network 108). From the gateway 206, data may be processed through a QOS engine 210 (e.g., QOS engine 110). The gateway 206 and QOS engine 210 may be represented as a software stack 212. Resulting data can be stored in a database 214, which, in various embodiments, may include or be a part of, for example, raw data store 112, operational database 114, data warehouse 116, and/or other databases, including, for example, databases of other users, customers, vendors, and/or carriers. Data from the database 214 may be available to various data users, such as, for example, applications and customers 220, which, in various embodiments, may include, for example, various applications 118 and insurance carrier systems 122, such as, for example, the Carrier Center, the Customer Center, and Actuarial Analysis. In some embodiments, data from the QOS engine 110 may be available directly to the various data applications and customers 220. In some embodiments, the various data applications and customers 220 may include various external or internal databases associated with one or more of the various data applications and customers 220. For example, data from the QOS engine 110 may be stored in database 214 for one data application 220 and may be stored in a different database associated with another data application 220. In some embodiments, data may be reported or displayed by the QOS engine and/or reported to a user, such as, for example, applications and customers 220 associated with the QOS engine, for example, for displaying and/or processing.

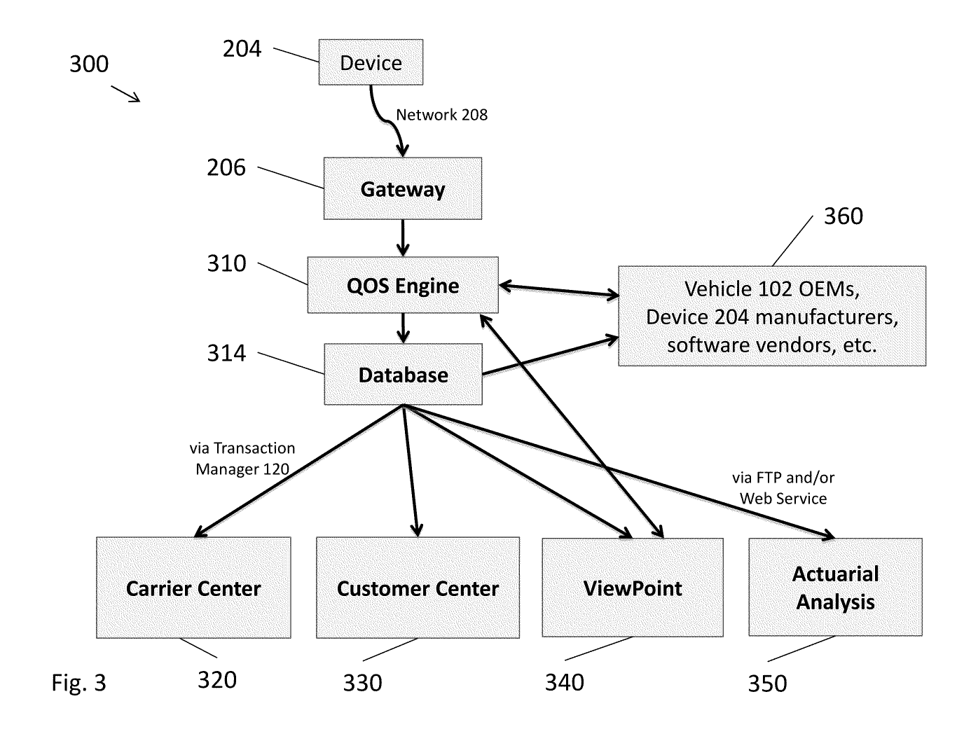

FIG. 3 shows another exemplary QOS framework 300. FIG. 3, as well as other figures, may make reference to elements described in other figures. In this exemplary framework 300, like framework 200, data associated with a vehicle 102 may be captured and/or transmitted from a device 204 to one or more gateways 206 via, for example, network 208. From the gateway 206, data may be processed through a QOS engine 310. Resulting data can be stored in a database 314, which, in various embodiments, may also include or be a part of, for example, raw data store 112, operational database 114, data warehouse 116, and/or other databases, including, for example, databases of other users, customers, vendors, and/or carriers. Data from the database 314 may be available to various users, such as, for example, a carrier center 320, a customer center 330, a management and/or interface application, such as, for example, Evogi Group's ViewPoint application 340, and/or an actuarial analysis process 350. Data from the database 314 may be available to users in a variety of ways, including, for example, directly via a transaction manager 120, for example, for the carrier center 320, customer center 330, and ViewPoint 340. Data from the database 314 may also be available to users via FTP and/or a web service, for example, for actuarial analysis 350.

Activities, such as, for example, data processing, data look-up, data display, data usage, etc., by various data applications and customers 220, such as, for example, the carrier center 320, the customer center 330, the ViewPoint application 340, and/or the actuarial analysis process 350, are dependent upon the quality of the data from devices 204, which are processed through the QOS engine 310. In order to properly and reliably execute their respective functions, the various data applications and customers 220 should receive data that meets a minimum standard of quality. Various exemplary data dependent actions, functions, uses, etc. that rely on data from the QOS engine 310 are included in the exemplary carrier center 320, customer center 330, ViewPoint application 340, and actuarial analysis process 350, which are described below.

A carrier center 320 may be, for example, a carrier center application that can provide carriers with a comprehensive customer support tool, for example, for provisioning and case management. The carrier center 320 can include a cloud-based business management application that can provide, for example, immediate role and/or permission directed data access for customer management, reporting, etc. The carrier center 320 may be configured to allow a customer service representative (CSR) of the carrier to handle all account and data management functions on behalf of the customer without interfacing with the carrier's policy management system, allowing the carrier center 320 to be the primary management system for UBI transactions. Exemplary data dependent transactions can include, for example, customer management, management reports, and general data access. The carrier center 320 may be part of or include an application, such as, for example, Evogi Group's Carrier Center.

Customer management transactions can include, for example, customer set-up (see also the customer center 330, described in more detail below), vehicle 102 set-up, logistics around order entry and device 204 fulfillment and return, and case management. Management report transactions can include, for example: a configurable dashboard; loss control, claims and underwriting reports; quotes and sales; vehicles 102; and cases. Data access transactions can include, for example, key performance indicator (KPI) reports and data downloads.

A customer center 330 may be, for example, a customer center application that can include, for example, displays of vehicle 102, driver, and/or driving data. A customer center 330 can include a configurable, “white label” customer service solution, such as, for example, Evogi Group's MyDriveAdvisor, for allowing customers to access information and data associated with UBI products. The customer center 330 can include, for example, a Software as a Service (SaaS) customer center with functionality that can manage and report data for each customer. The customer center 330 may be part of or include an application, such as, for example, Evogi Group's Customer Center.

Additional data dependent functionality may be configured by a carrier and delivered to a customer via the customer center 330, including, for example: customers' online acknowledgement and/or acceptance of data capture and use for insurance products; communication systems that can deliver targeted, real-time messages about driving behavior, vehicle 102 performance, insurance rates and discounts, game-based interactions, and community results, etc., via, for example, online or text messages; dashboards that can give customers an overview of their driving behavior and vehicle score for all vehicles 102; detailed historical views of driving behavior and metrics that can be coupled with driving behavior management reporting and tools associated with UBI products; integration points with the carrier center 320 for support services; value-adds and location-based services, such as, for example, roadside assist, teen and senior driver monitoring and/or management; and integrated smart-phone applications.

The Evogi Group's ViewPoint application 340 is shown as an exemplary application for managing and/or interfacing with the QOS engine 310 and/or database 314. Various other applications may also be used, including those with similar feature sets. In one embodiment, ViewPoint 340 includes a data visualization tool and programming interface tool. ViewPoint 340 may be built with an underlying platform, such as, for example, using QlikView®. In one embodiment, a management and/or interface application, such as, for example, ViewPoint 340, includes three key tools: a QOS dashboard, a Web Analytics dashboard customized for particular customers, such as, for example Evogi Group's customers, and an accelerometer dashboard. An accelerometer dashboard may allow carriers and/or actuaries to analyze accelerometer data that are captured, for example, at 4 times per second, from a device 204.

A QOS dashboard can interface with the QOS engine 310 and display data from the QOS engine 310 and/or database 314. For example, the manager of the QOS engine 310, such as, for example, the Evogi Group and/or an authorized manager and/or carrier, can use the QOS dashboard as a programming interface to establish, monitor, add, remove, modify, etc., the standards, rules, flags, etc., associated with the QOS engine 310. In another embodiment, the QOS dashboard may be a user interface, for example, to only display data, such as, for example, to a customer, carrier, other third party, etc. In other embodiments, the QOS dashboard of the management and/or interface application, such as, for example, the QOS dashboard of ViewPoint 340, may function differently or have different capabilities for different users, for example, in various combinations of the above-mentioned scenarios. Capability access for the management and/or interface application and/or any of the other various data applications and customers 220 may be managed, for example, with user-specific login credentials.

An actuarial process 350 may be a carrier's native actuarial system or other actuarial system. In a UBI system, driving performance may be used to develop a vehicle 102 score or rating based on, for example, quantifiable driving behavior or events that may be related to insurance risk. In one embodiment, the actuarial process 350 can determine an actuarial value associated with a vehicle 102 score or rating. In other words, for example, the actuarial process 350 can determine how much or how little a vehicle 102 score or rating will be worth when a new rate is calculated based on the driving behavior monitored by a UBI system. After the carrier determines a new rate, a restatement of price may be offered to the customer.

In some embodiments, the QOS engine 310 and database 314 may also exchange data with other entities 360, such as, for example, vehicle 102 OEMs, device 204 manufacturers, software vendors, etc. For example, information from the QOS engine 310 and database 314 may assist continuous improvement efforts by the entities 360 to improve the manufacturing quality of the device 204, the installed location and/or orientation of the device 204 with a vehicle 102, the quality of data from the device 204, etc., as discussed in more detail below.

For example, the QOS engine 310 can evaluate and categorize each data packet transmitted by a device 204 against user requirements, such as, for example, accuracy, reliability, and/or quality of data, which make the data suitable for display, implementation, and/or modification of an aspect of a UBI program, for example, within one or more of the data applications and customers 220. The data packet can be aggregated by trip and evaluated, for example, for accuracy and suitability. In addition, standards may also be established for determining when and how to display data within various data and customer applications 220, including, for example, the above-mentioned carrier center 320, customer center 330, ViewPoint application 340, and actuarial analysis process 350.

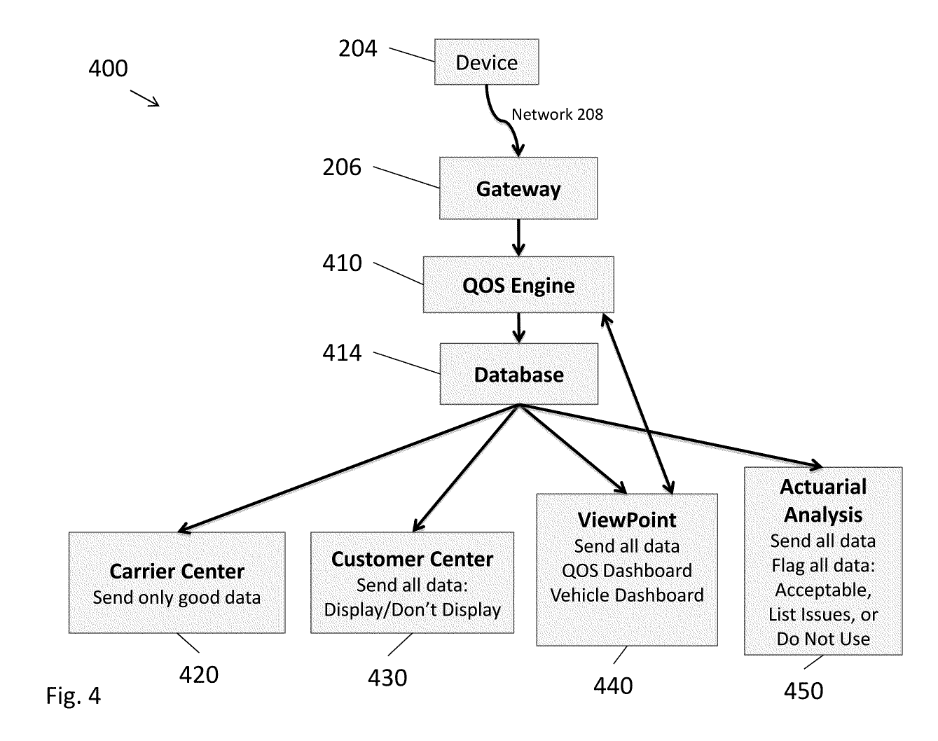

FIG. 4 shows another exemplary QOS framework 400. This QOS framework 400 is similar to the QOS framework 300 of FIG. 3, but includes a QOS engine 410 with specific exemplary quality standards, for example, for the acceptance of data, the display of data, and the display protocols for exemplary data users/applications. Data from a database 414 may be available to various exemplary data applications and/or users, such as, for example, a carrier center 420, a customer center 430, a ViewPoint application 440, and an actuarial analysis process 450. In various embodiments, data from the QOS engine 410 can be transferred to the database 414 and may be routed to any or all of these exemplary applications and/or other data applications and/or users.

For example, according to the standards established for the QOS engine 410 of QOS framework 400, only good data are reported or sent to the carrier center 420. Good data may be defined as any data meeting the quality standards established in the QOS engine 410. For the customer center 430, all of the data are sent, accompanied by display information. For example, the data not fit for normal display may be flagged for a qualified or conditional display (e.g., Display_Cloud) or flagged to not display (e.g., Display_Hide). In a particular embodiment, for example, if a vehicle 102 is parked in a parking garage, a fairly accurate location may be known, but the precise vehicle 102 location within the garage (e.g., floor, parking space, etc.) may not be known. In this example, location data may be displayed in a qualified or conditional manner to communicate to the user the imprecise but relatively accurate location of the vehicle 102. For example, the location data on a virtual world map may include an image of the parking garage and a small cloud over the garage to denote the approximate location of the vehicle 102, but not the precise location (e.g., using the Display_Cloud flag). This “rough” mapping method may also be used in other instances where the data are fairly accurate but not precise. In different embodiments, this type of data may or may not be used for processing, such as, for example, scoring algorithms.

For the ViewPoint application 440, all of the data are sent and are viewable, for example, via a QOS dashboard and/or a Vehicle Dashboard, where is it defined. In an exemplary QOS Dashboard of the ViewPoint application 440, QOS metrics can be displayed within a rules-based, customized dashboard for each user-group, for example, policyholders, insurance actuaries, and insurance carrier customer service staff, as described in more detail below. For the actuarial analysis process 450, all of the data are sent along with a flag, for example, with one of three indicators: acceptable; usable if issues identified are acceptable; and do not use. Flags may be used to identify certain aspects of the data that can be used for determining how to treat the data, for example, whether to report, send, retain, display, use for computations associated with the UBI product, etc.

The QOS framework 400 can report and/or display the data from the QOS engine 410 differently for each application, for example, to suit particular functions of each application. For example, data sent to and available in the carrier center 420 can be used, for example, to report on mismatches between devices 204 and vehicles 102 as established in a policy, detect unplugging of devices 204 from OBD ports, and if unplugged, report for how long, what distance driven, number of occurrences, etc.

In another example, data sent to and available in the customer center 430 can be used to, for example, provide alerts for missing trips, correct trips with minor data quality issues, change to “cloud” view portions of trips with some data quality issues, and remove trips with major data quality issues.

In another example, data sent to and available in the ViewPoint application 440 can be used, for example, to report on data quality and ensure that data meets minimum quality levels before being used in visualizations.

In another example, data sent to and available in the actuarial analysis process 450 can be used, for example, to show data quality from devices 204, trips, and readings, including identifying whether that data: is ideal; has some issues (flags can describe issues); and/or is not to be used for calculations.

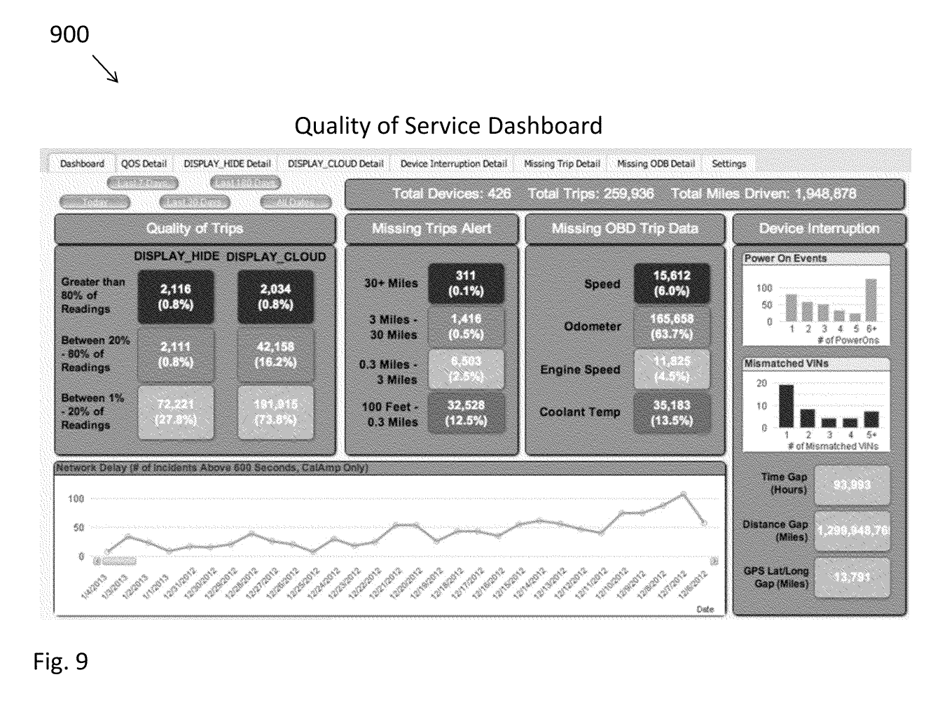

Exemplary screenshots of the QOS data available in various applications, including ViewPoint application 440, are shown in FIGS. 9-15, and described in more detail below.

With further reference to the block diagrams of FIGS. 2-4, after clearing the gateway 206 and completing any applicable data aggregation and normalization processes, each packet of information is subjected to various rules and/or algorithms in the QOS engine 210, 310, 410, such as, for example, for accuracy, reasonability, and fraud detection. Further rules and/or algorithms in the QOS engine 210, 310, 410 may determine other data treatment, for example, whether data are displayed, stored, and/or discarded.

Some devices 204 can send many samples within the same data packet. For example, a device 204 may send 30 1-second samples every 30 seconds as one DeviceMessage. As part of an exemplary data aggregation and normalization process, a routine, such as, for example, Evogi Group's Historian Worker routine, can convert each sample within a DeviceMessage into a separate HistoricalReading before subjecting the data to the QOS process of a QOS engine 210, 310, 410. A HistoricalTrip may be a group of HistoricalReadings.

As illustrated in this application, blocks or steps of flowcharts represent logic functions, actions and/or events performed therein. It will be appreciated by one of ordinary skill in the art that electronic and software systems involve dynamic and flexible processes such that the illustrated blocks and described sequences can be performed equivalently in different sequences or in parallel. It will also be appreciated by one of ordinary skill in the art that elements embodied as software may be implemented using various programming approaches such as, for example, machine language, procedural, object-oriented, or artificial intelligence techniques. It will further be appreciated by one of ordinary skill in the art that, if desired and appropriate, some or all of the software can be embodied as part of an operating system.

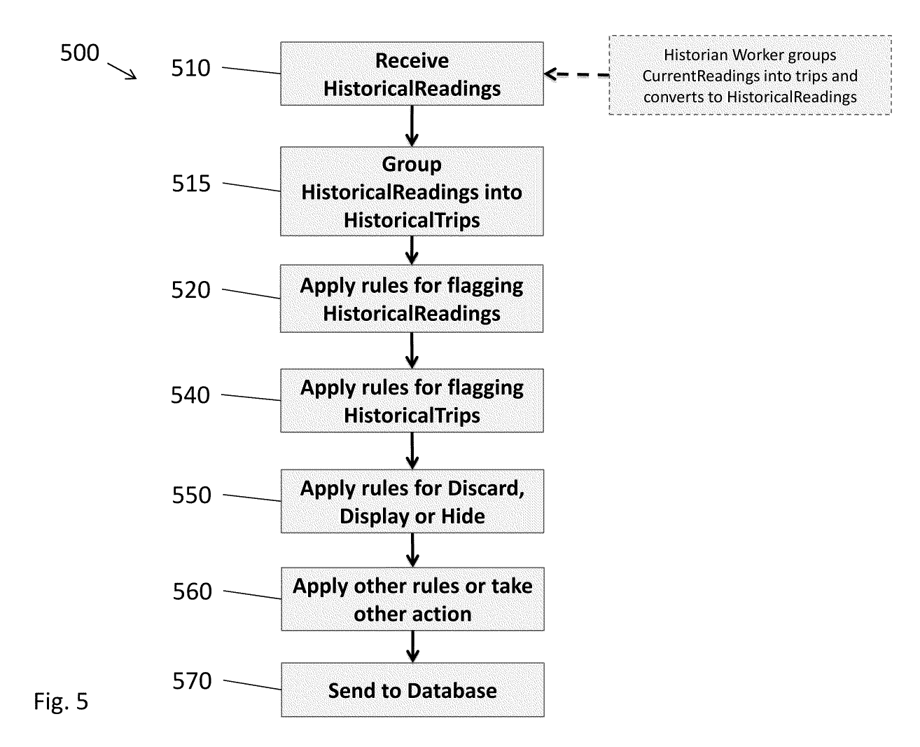

An exemplary QOS engine 210, 310, 410 may include an exemplary QOS process 500, as shown in the flowchart of FIG. 5. The process can start at 510 where the QOS process 500 receives HistoricalReadings, for example, from the Historian Worker routine. Each HistoricalReading and HistoricalTrip (e.g., group of readings) can have an associated set of QOS flags that start out empty before the QOS process 500 processes the data. As can be appreciated by one skilled in the art, in other embodiments, various flags may start filled and be toggled empty in a similar fashion with equivalent results. At step 515, the HistoricalReadings can be converted into or grouped into HistorialTrips. At step 520, the QOS process 500 can apply rules for flagging the HistoricalReadings. The QOS rules of the QOS process 500 implement the QOS standards. The QOS rules may include first flagging each HistoricalReading, and then may flag the HistoricalTrip. At step 540, the QOS process 500 can apply the rules for flagging the HistoricalTrips in a manner similar to flagging HistoricalReadings. At step 550, the QOS process 500 can apply QOS rules for discarding, displaying, or hiding data. At step 560, one or more other QOS rules may be applied to the data and/or actions may be taken, as described in more detail below. At step 570, the processed data, including any associated flags, can be sent to a database, such as, for example, database 214, 314, 414. In other embodiments, data can be made available directly to applications, including those with and without internal databases.

Referring in more detail to the rules for selectively flagging data in step 520, after HistoricalReadings are generated from data gathered from each packet of information, the QOS rules or algorithms for determining whether and how to display each HistoricalReading are implemented. For example, for each HistoricalReading, the QOS process 500 determines whether and how that particular HistoricalReading will be treated, such as, for example, whether that particular HistoricalReading will be sent to the carrier center 430 or will be displayed on the QOS dashboard of ViewPoint 440. These treatment decisions can be based on several factors that may be included in the QOS rules. For example, various flags associated with these factors can be set for certain conditions or standards.

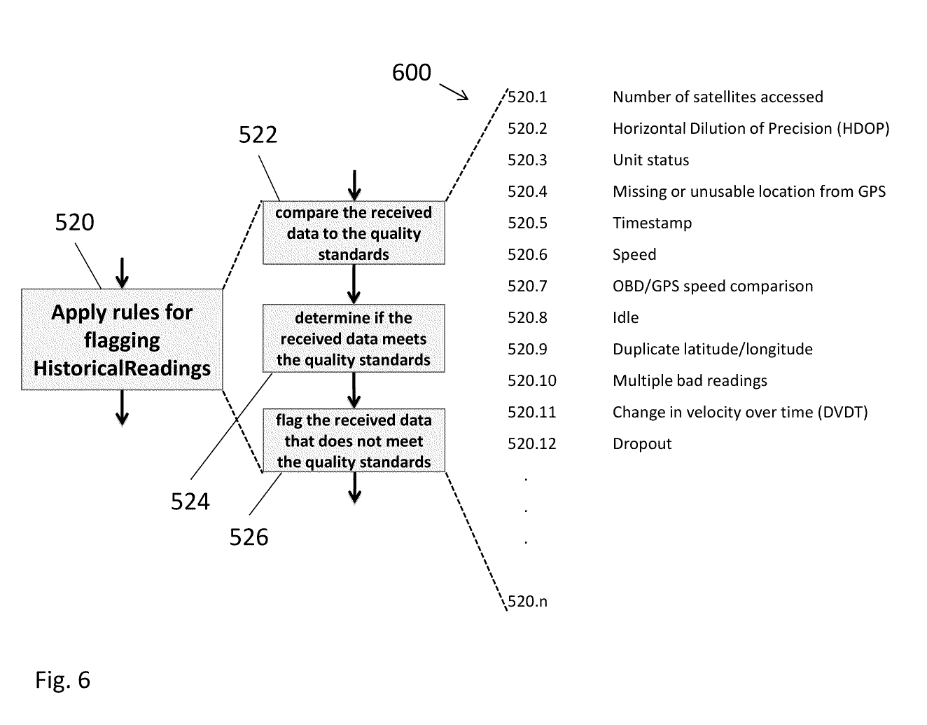

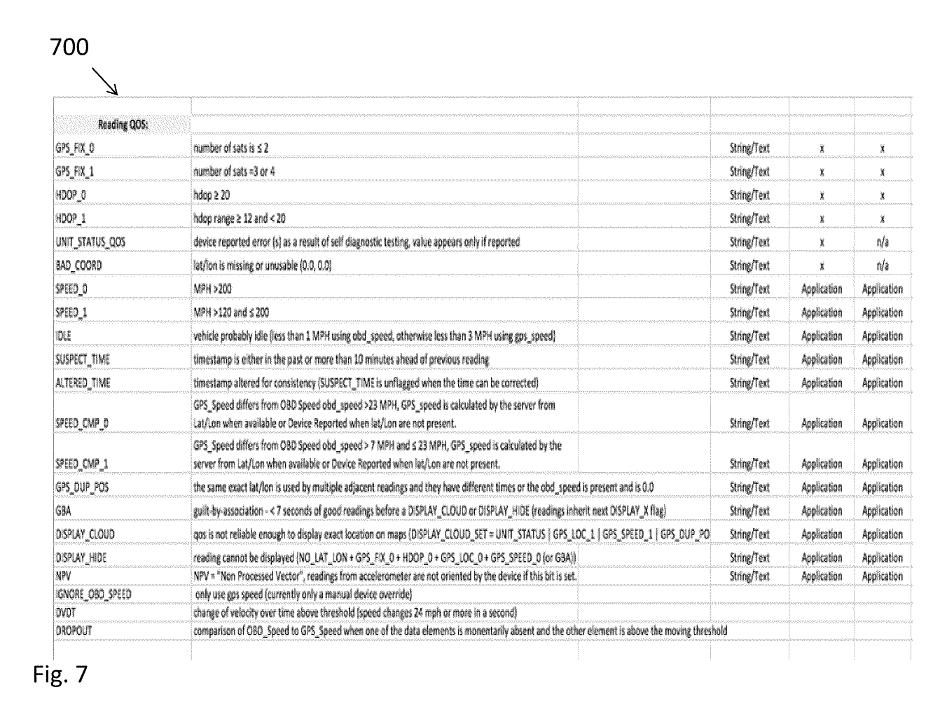

FIG. 6 shows an exploded block diagram/flowchart of exemplary steps that may be included in step 520 of FIG. 5. At step 522, the QOS process 500 can compare the received data to the quality standards. At step 524, the QOS process can determine if the received data meets the quality standards. At step 526, the QOS process can flag the received data that does not meet the quality standards. FIG. 6 also includes an exemplary list 600 of various standards and attributes that may be included when applying the rules for flagging HistoricalReadings 520.

HistoricalReadings may contain data about any number of measurables, as discussed in detail below. MessageFields indicate the type of data that are included in any HistoricalReading. Typically, a HistoricalReading is only subjected to the quality standards applicable to the data that it contains, as identified, for example, by the MessageField(s) included with the data. In this manner, a flag related to a particular quality standard may only be set for a HistoricalReading when the HistoricalReading contains data applicable to that standard. For example, a HistoricalReading that does not contain data regarding the number of satellites will not be subjected to the quality standard for the number of satellites (e.g., GPS_FIX, as discussed in detail below). Using GPS_FIX as an example, GPS_FIX_{—}0 (representing that the # of satellites is <3 for a particular DeviceMessage) would not be flagged for a reading that does not contain the number of satellites. In various embodiments, the rules can be established to first check for the presence of the MessageField(s) before setting a flag.

As shown in the examples below, the names of the flags are in capital letters in parentheses with a description of the factor. As shown in the exploded block diagram/flowchart of FIG. 6 and table 700 shown in FIG. 7, any number of factors, standards, attributes, predetermined thresholds, and associated flags may be included in a QOS engine 210, 310, 410 and/or QOS process 500 for evaluating HistoricalReadings data, including the following examples:

520.1—Number of satellites accessed (GPS FIX): For example, an average of 7 satellites may be considered good. For example, two conditions may be flagged: if # of satellites is <3 (GPS_FIX_{—}0) OR if # of satellites=3 or 4 (GPS_FIX_{—}1).

520.2—Horizontal dilution of precision (HDOP): For example, an HDOP below 12 may be considered good. For example, two conditions may be flagged: HDOP>=20 (HDOP_{—}0) OR HDOP>12 and <20 (HDOP_{—}1).

520.3—Unit status: For example, unit status can be used to document tests of the performance of a device 204, such as, for example, a GPS unit, GPS antenna, modem, and modem antenna. The performance may be measured periodically, such as, for example, once per second. A flag may be set if any device-specific failure codes are present (UNIT_STATUS).

520.4—Missing or unusable location from GPS: For example, based on calculated speed between two latitudes and longitudes, reported, for example, in miles per hour (MPH), two conditions may be flagged: MPH>200 (SPEED_{—}0) OR MPH>120 and <200 (SPEED_{—}1). A flag may also be set if latitude or longitude=0.0, indicating bad coordinates (BAD_COORD).

520.5—Timestamp: For example, each packet may include a GPS timestamp. A flag may be set when timestamp<2011-01-01 or > time of QOS processing (SUSPECT_TIME).

520.6—Speed: For example, suspect readings may be flagged if GPS speed>=200 MPH (SPEED_{—}0) OR speed is >=120 mph and <200 MPH (SPEED_{—}1).

520.7—OBD/GPS speed comparison: For example, speed may be captured from more than one source, for example, from a GPS system and from an OBD system. When the speed comparison is calculated, flags may be set if the difference between the two readings is >23 MPH (SPEED_CMP_{—}0) OR the difference is >7 and <=23 MPH (SPEED_CMP_{—}1).

“OBD” refers to data originating from the OBD connector, which connects the device 204 to the vehicle 102 and can capture data generated by the vehicle 102. In contrast, “GPS” data, such as GPS_SPEED, are generated by the device 204 itself.

520.8—Idle: For example, a flag may be set if device 204 speed <1 MPH and GPS speed is <3 MPH (IDLE).

520.9—Duplicate latitude/longitude: For example, even when a vehicle 102 is stationary, the latitude/longitude readings may not stay the same, due to variation in satellites readings. A reading may only be flagged if the adjacent reading contains any of [BAD_COORD|SPEED_{—}0|SPEED_{—}1|SPEED_CMP_{—}0|SPEED_CMP_{—}1|GPS_DUP_POS]. The reading will also inherit the previous flags from the adjacent reading. For example, reading1 has SPEED_{—}0 flagged. Reading2 contains the exact same latitude and longitude. Reading two will be flagged with both (SPEED_{—}0) and (GPS_DUP_POS).

520.10—Multiple bad readings: For example, a flag may be set if <7 consecutive seconds of displayable readings are captured. This may be referred to as “guilt by association” (GBA). Note that a “displayable” (DISPLAYABLE) reading is a reading that does not contain (DISPLAY_HIDE) or (DISPLAY_CLOUD) flags.

520.11—Change in velocity over time (DVDT): For example, a flag may be set if the vehicle 102 speed changes more than 24 MPH per second.

520.12—Dropout: For example, a flag may be set when a combination of readings indicates the device 204 is “dropping” data or is otherwise non-reporting (DROPOUT). For example:

(OBD speed=0.0 & GPS speed !IDLE)∥(OBD speed !IDLE & GPS speed=0.0)∥(IDLE & last reading=DROPOUT).

The above factors, flags, and associated thresholds are exemplary. A virtually unlimited number of other factors and combinations of factors may also be utilized to implement various QOS rules and standards. In some embodiments, a QOS manager and/or a carrier can add, remove, prioritize, ignore, modify, update, etc., existing or additional standards, rules, factors, flags, and/or combinations thereof, etc., as data are processed and understood.

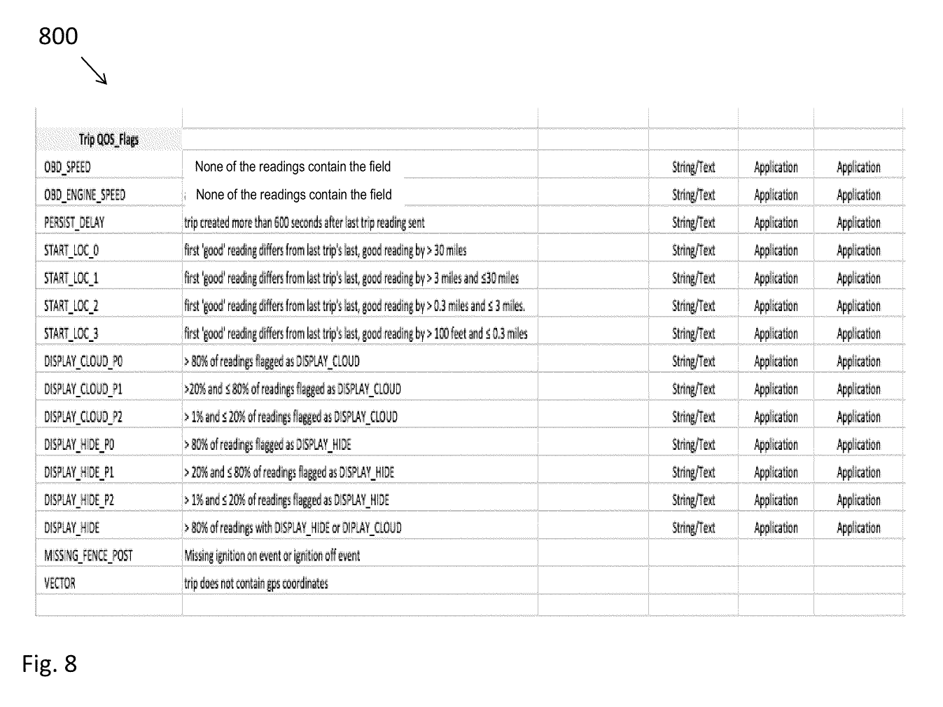

As mentioned above, as part of step 515, HistoricalReadings may be aggregated into a HistoricalTrip, for example, within a data aggregation and normalization process. As part of step 540, several exemplary flags may be set for a HistoricalTrip. Similar to the HistoricalReading flags and process steps shown in FIGS. 6-7, any number of factors, standards, and associated flags may be included in a QOS engine 210, 310, 410 and/or QOS process 500 for HistoricalTrips, as shown in table 800 of FIG. 8, including the following examples:

In one example, for missing device 204 data, a flag may be set if a trip does not contain at least one reading of speed, odometer, engine speed (RPM), and/or coolant level:

OBD_SPEED:: no readings had OBD speed

OBD_ENGINE_SPEED:: no readings had OBD engine speed

OBD_ODOMETER:: no readings had OBD odometer
OBD_CALC_ODOMETER:: no readings had OBD calculated odometer

In another example, regarding timely delivery, when a vehicle 102 is turned off and a trip is created, the trip should be transmitted within minutes. A flag can be set if the interval from trip creation to arrival in the database 214, 314, 414 (e.g. “persistent delay”) is >10 minutes:

PERSIST_DELAY:: time between trip end and trip creation>10 minutes

In another example, a start location flag can be based on comparing the first ‘good’ trip reading to the last trip's last reading. Indicators can be set, for example, for four levels of location variation, for example, ranging from >100 feet to >30 miles:

START_LOC_{—}0:: 30 mi<trip_dist_from_last

START_LOC_{—}1:: 3 mi<trip_dist_from_last<=30 mi

START_LOC_{—}2:: 0.3 mi<trip_dist_from_last<=3 mi

START_LOC_{—}3:: 100 feet<trip_dist_from_last<=0.3 mi

As part of step 550, readings may be flagged as suspect or displayable. Suspect readings can be discarded. Displayable readings can be retained and may be displayed to some or all of the various data and customer applications 220, including, for example, the above-mentioned carrier center 420, customer center 430, ViewPoint application 440, and actuarial analysis process 450, based on rules for each application, for example:

SUSPECT_LOCATION:: UNIT_STATUS∥HDOP_{—}1∥GPS_FIX_{—})∥BAD_COORD∥GPS_DUP_POS

DISPLAYABLE:: !(DISPLAY_CLOUD∥DISPLAY_HIDE)

Also part of step 550, instructions for displaying data (DISPLAY_CLOUD) or hiding data (DISPLAY_HIDE), for example, for the customer center 430, are created within the QOS engine 210, 310, 410, for example, based on these rules:

DISPLAY_HIDE: Only the first rule in the following whose conditions are met is used.

When locatable:: BAD_COORD∥GPS_FIX_{—}0∥HDOP_{—}0∥SPEED_{—}0∥SPEED_CMP_{—}0 (A locatable reading contains both latitude and longitude.)

When obd_speed is present:: SPEED_{—}0∥SPEED_{—}1∥SPEED_CMP_{—}0∥SPEED_CMP_{—}1∥DVDT∥DROPOUT

When gps_speed is present:: SPEED_{—}0∥SPEED_{—}1∥SPEED_CMP_{—}0∥SPEED_CMP_{—}1∥DVDT∥DROPOUT∥POOR_GPS∥GPS_DUP_POS

HistoricalTrips that are displayable can be labeled based on these rules. A trip that is flagged as DISPLAY_HIDE is not displayable:

DISPLAY_CLOUD_P0:: %80<percentage of DISPLAY_CLOUD readings

DISPLAY_CLOUD_P1:: %20<percentage of DISPLAY_CLOUD readings<=%80

DISPLAY_CLOUD_P2:: %01<percentage of DISPLAY_CLOUD readings<=%20

DISPLAY_HIDE_P0:: %80<percentage of DISPLAY_HIDE readings

DISPLAY_HIDE_P1:: %20<percentage of DISPLAY_HIDE readings<=%80

DISPLAY_HIDE_P2:: %01<percentage of DISPLAY_HIDE readings<=%20

DISPLAY_HIDE:: percentage of DISPLAY_HIDE and DISPLAY_CLOUD readings>%80

MISSING_FENCE_POST:: trip does not contain an ignition on or off event

VECTOR:: all readings are not locatable. (A locatable reading contains both latitude and longitude.)

As part of step 560, the QOS engine 210, 310, 410 and/or QOS process 500 can also include various other rules and/or take other actions related to ensuring that data meets a variety of quality standards. In various embodiments, at step 560, an assortment of techniques may be employed to determine and react to, for example, mismatched vehicles 102 and devices 204, potential fraud, hardware/device 204 issues, signal analysis, etc.

Regarding mismatched vehicles 102 and devices 204, for example, the first time a device 204 is connected with a vehicle 102, for example, plugged into the OBD port of a vehicle 102, a “power on event” finds the vehicle 102 protocol and reads the vehicle 102 VIN. Using the VIN as a vehicle 102 ID, a QOS engine 210, 310, 410 and/or QOS process 500 can compare the vehicle 102 ID with the enrolled vehicle 102 for that device 204. Mismatches between vehicle 102 and device 204 can trigger a message to the carrier.

Regarding fraud detection, one or more techniques may be used to detect potentially fraudulent activities. For example, if a device 204 is unplugged, the unplug event can be time stamped and compared to the next plug-in time. Long delays in re-plugging the device 204 may indicated an attempt to avoid tracking. In another embodiment, the location of a device 204, for example, by latitude and longitude, when un-plugged and re-plugged may be compared, including, for example, to calculate miles driven while unplugged.

In another example, the number of times a device 204 is unplugged can also be logged. A large number of unplugs of the device 204 may indicate fraud.

In another example, the odometer reading may be captured when the device 204 is unplugged. This value may be compared to the odometer reading when the device 204 is plugged back in again. Gaps in odometer readings may indicate fraud.

In another example, the vehicle 102 VIN number may be compared with the VIN number associated with the account to ensure that the device 204 is plugged into the correct vehicle 102. If the VIN number cannot be read from the vehicle 102, then the OBD protocol type can be compared to the expected vehicle 102 make and model to determine if it matches the expected protocol.

In an exemplary embodiment, a carrier may use miles driven as a rating variable. For example, a customer who drives long distances for work may unplug a device 204 before returning home from work, in an attempt to avoid being penalized for excessive miles. However, the latitude/longitude calculation can determine the miles driven from the last unplug until the re-plug in, which can be sent to the carrier. In the circumstance where the customer re-plugs in the device 204 at the same geographical location as the unplug event, the odometer reading capture feature may also detect the potential fraud.

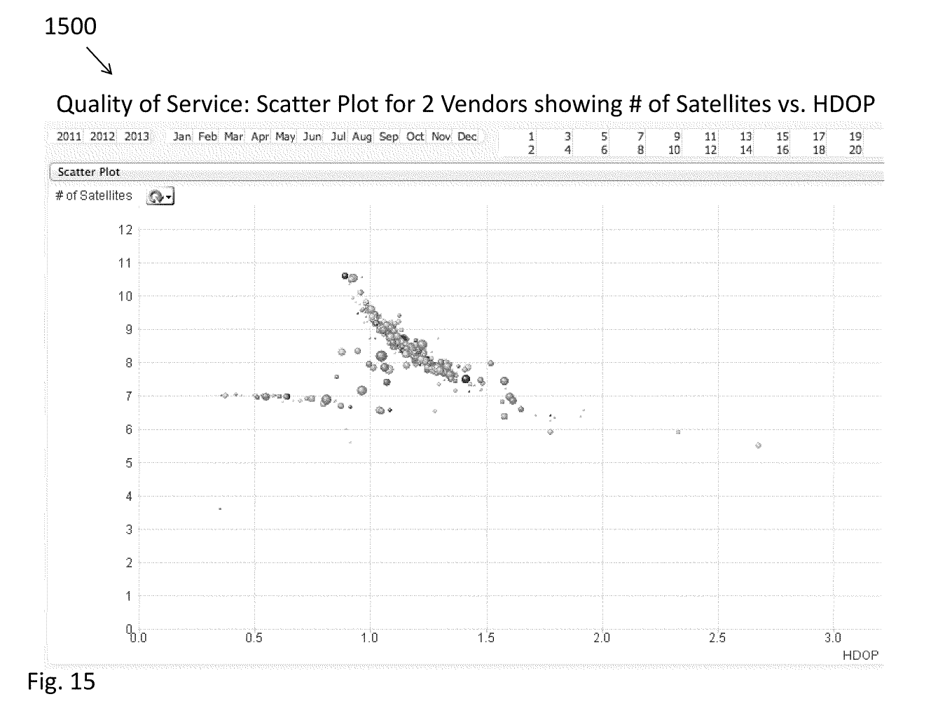

Regarding vendor hardware/device 204 analysis, in one example, aggregate data may be mapped to a scatter diagram showing average number of satellites accessed vs. received signal strength indication (RSSI). (See, for example, FIG. 15, described in more detail below). This analysis can identify outliers that may allow for the identification and fulfillment of the most effective device 204 by vehicle 102 make and model. For example, an Audi TT may have sheet metal in a location that blocks the signal from a device 204 plugged into the OBD port. Various devices 204 may perform better than others in these types of shielded environments. Real-world data can be used to identify the best device 204 for this particular vehicle 102.

Regarding geographic RSSI analysis, in one example, signal quality can be tracked on a mobile network and plotted geographically. If RSSI is weak, for example, a trip may not close out and may not be transferred to the gateway 206 until the vehicle 102 returns to a location with greater signal strength. Signal quality data can be used to assist customer service representatives, for example, to answer questions from customers about why a trip was not displayed. In another example, data may also be fed to the customer center 330, 430 to allow the customer to check trips that appear incorrect and see the associated RSSI data for those trips. For example, a customer may live in a rural community with poor signal quality and may work in a city where the signal is strong. Upon returning home and turning off the vehicle 102, the trip does not “close out” because the data cannot be sent due to the weak signal. When the vehicle 102 is started the next day and travels closer to the city, the trip can “close out” and then immediately start a new trip. In this situation, it is likely that the GPS Duplicate latitude/longitude test will capture multiple identical GPS readings and 0 MPH readings, labeling the trip data unusable. If the data are reported, the aggregate geographic RSSI data can help determine the reason for the faulty data.

Returning to FIG. 5, at step 570, data may be transferred and/or selectively reported to database 214, 314, 414 and/or may be routed to any or all data applications and customers 220, including to, for example, with further reference to FIG. 4, as discussed above: the carrier center 420—only good data are sent; the customer center 430—all data are sent, accompanied by display or hide instructions; the ViewPoint application 440—all data are sent; and the actuarial analysis process 450—all data are sent with indicators, for example, acceptable, usable if issues identified are acceptable, and do not use.

In other embodiments, the QOS engine 310 and database 314 may also exchange data with other entities 360, as shown in FIG. 3, such as, for example, vehicle 102 OEMs, device 204 manufacturers, software vendors, etc. In these embodiments, for example, QOS data may be provided for the purpose of improving the performance of particular vehicles 102, devices 204, and/or software. For example, information from the QOS engine 310 and database 314 may assist continuous improvement efforts by the entities 360 to improve the manufacturing quality of devices 204, the installed location and/or orientation of devices 204, the quality of data from devices 204, the software to capture, process, and transmit data etc. For example, aggregate data may be provided to entities 360 from the following exemplary categories discussed above: Number of satellites accessed; HDOP; Unit status; Missing or unusable location from GPS; Timestamp; GPS speed; Duplicate latitude/longitude; Missing OBD data; Timely delivery; etc.

In particular, these embodiments may be useful as devices 204 are replaced by vehicle 102 OEM technology with device 204 capabilities included in new vehicles 102. For example, such vehicle 102 OEM equipment may be susceptible to the same hardware, software, and/or antenna issues as non-OEM equipment.

In addition to the embodiments above that include an exemplary UBI environment, the QOS engine 210, 310, 410 and/or QOS process 500 is also well suited for other driving performance applications, including, for example, fleet management for commercial auto insurers and self-insurers. In these embodiments, certain data, standards, flags, etc., may be focused differently based on the particular needs of an insurer, for example. In these embodiments, the QOS engine 210, 310, 410 and/or QOS process 500 has the capability to ensure quality data, for example, associated with driver behavior and vehicles 102, is provided for feedback and analysis, which may be very useful, for example, to determine and minimize risk.

The ViewPoint application 440 may be a useful tool for users of all of the above embodiments. As mentioned above, all of the data may be sent to the ViewPoint application 440 and may be viewable, for example, via a QOS dashboard and/or a vehicle dashboard, by, for example, the QOS engine 410 manager and/or carriers. In an exemplary QOS dashboard of the ViewPoint application 440, QOS metrics can be displayed within a rules-based, customized dashboard for each user-group, for example, policyholders, insurance actuaries, and insurance carrier customer service staff. The overall quality of a carrier's UBI program is highly dependent upon good data from devices 204.

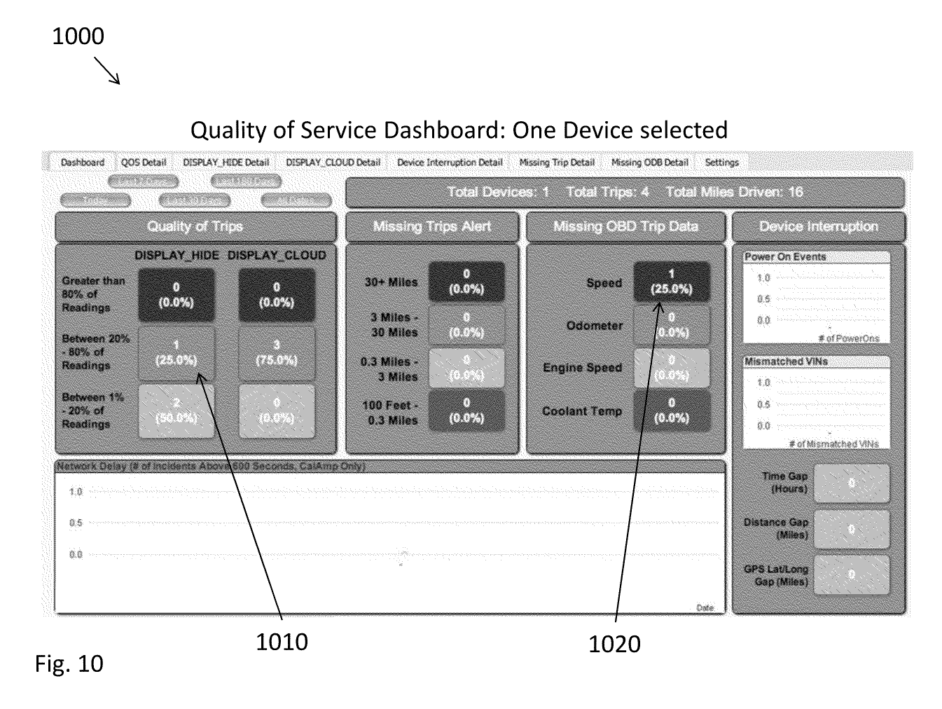

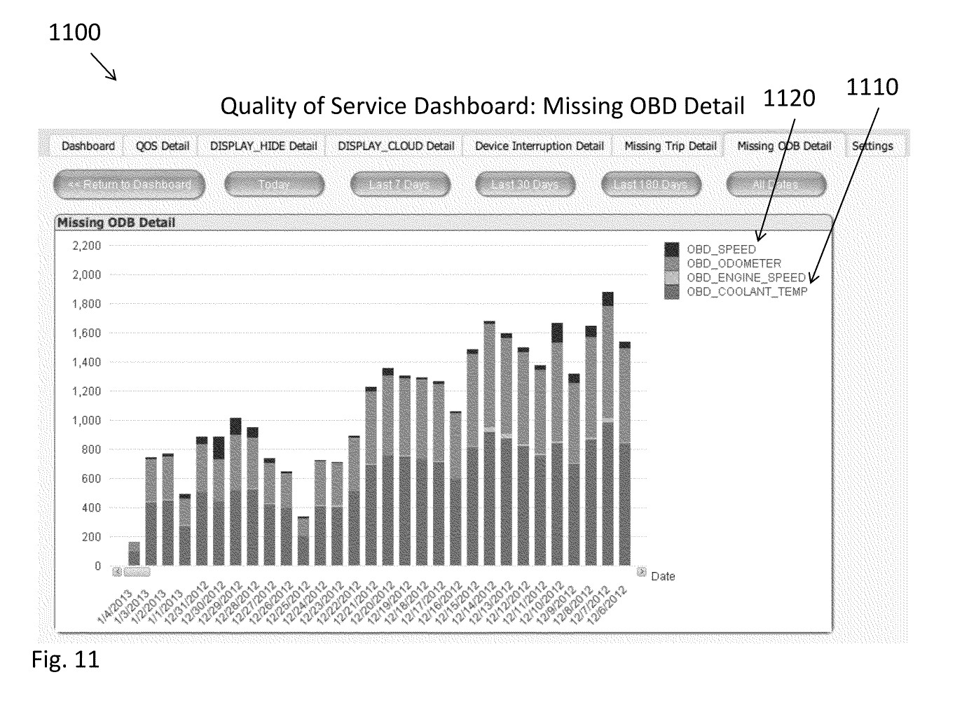

FIG. 9 shows a screenshot 900 of an exemplary home page of a QOS dashboard. In various embodiments, a carrier can access the QOS dashboard through the ViewPoint application 440. This screenshot includes exemplary summary data for a specified group of vehicles 102 that have devices 204 installed and are transmitting data. Data can be tracked from the inception of the carrier's UBI program and may be displayed, for example, for the current day, last 7 days, last 30 days, last 90 days and inception to date, allowing the carrier to observe trends and significant changes. An actuary or product manager may use the data to make decisions about UBI program design, the use of rating variables and possible data elements to include and/or exclude from the UBI product. The exemplary view may be changed to include all vehicles 102 or a defined subset of the vehicle 102 population (as shown below in FIG. 10).

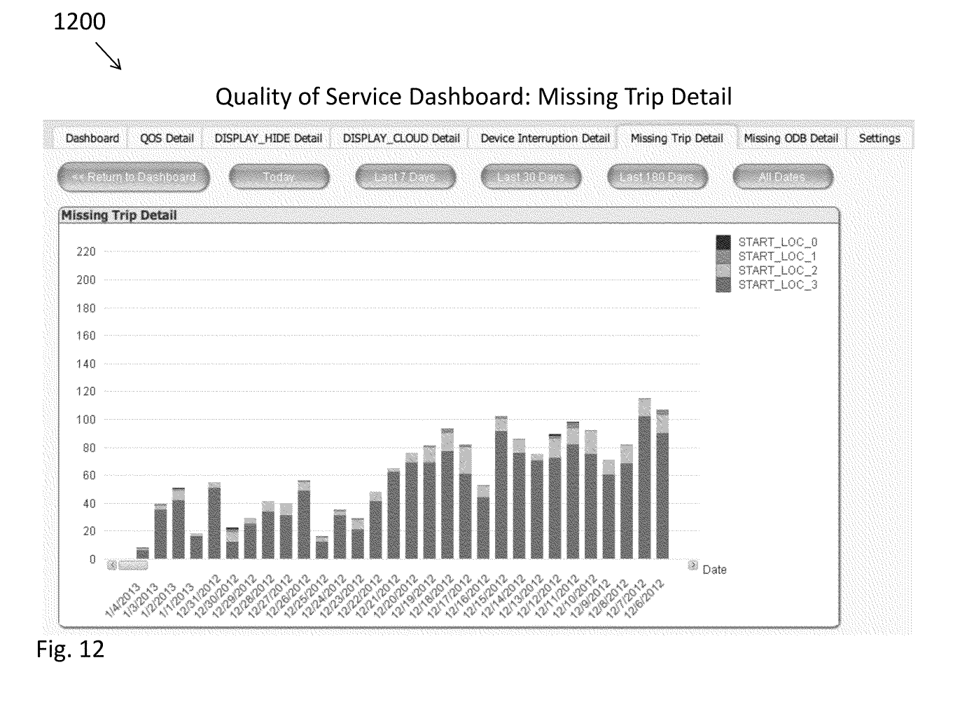

FIG. 10 shows a screenshot 1000 of an exemplary view showing one vehicle 102/device 204. Data for four trips has been captured and are displayed, covering 16 miles driven. From the displayed data, a user can make various observations, for example, regarding the quality of trips. For example, as shown by 1010, data for one trip was flagged Display_Hide (e.g., and not displayed in the customer center 430) because between 20% and 80% of the readings that comprised this trip were of poor quality. It may be likely that there was a disruption in the transmission of data during this trip and displaying this data could be confusing to the user of the customer center 430 (e.g., driver), so it is flagged to be hidden. In another example, as shown by 1020, during one trip, OBD Speed was not captured, so one trip is flagged. Missing OBD Speed may be a relatively rare occurrence (as shown in more detail below in FIG. 11).

FIG. 11 shows a screenshot 1100 of an exemplary view of the underlying detail for OBD data about the engine performance. Where there is an increase in the number of observations of a missing detail, for example, the engine coolant temperature, as shown by 1110 in this example, the data may be excluded or given less weight in an algorithm. Where there are very few instances of missing data, as with OBD speed in this example, as shown by 1120, the data may be deemed highly reliable and may be given more weight in an algorithm. Tracking trends over time may be useful. For example, observing a decline in quality of data associated with a new firmware release could quickly alert a vendor to an emerging issue. For example, in this slide, a positive trend in the number of missing details observed after Dec. 23, 2012, which may be associated with or be used to verify a fix, such as, for example, a firmware fix.

FIG. 12 shows a screenshot 1200 of an exemplary view of missing trips details. Alerts can compare the location of the vehicle 102 at power off to the location of the vehicle 102 at the next power on event. For example, Start_LOC_{—}0 indicates that the difference between power OFF and the next power ON was a distance of 30+ miles. This data may indicate several potential issues, such as, for example: a vehicle 102 was towed—valuable information to a carrier, as it may indicate there was an accident; a device 204 was malfunctioning—valuable to the carrier and customer, who are relying on accurate data for rate-setting; and a device 204 was removed and the vehicle 102 was driven—valuable to the carrier as it may indicate fraud, meaning the consumer may be unplugging the device 204 to avoid sending data about trips.

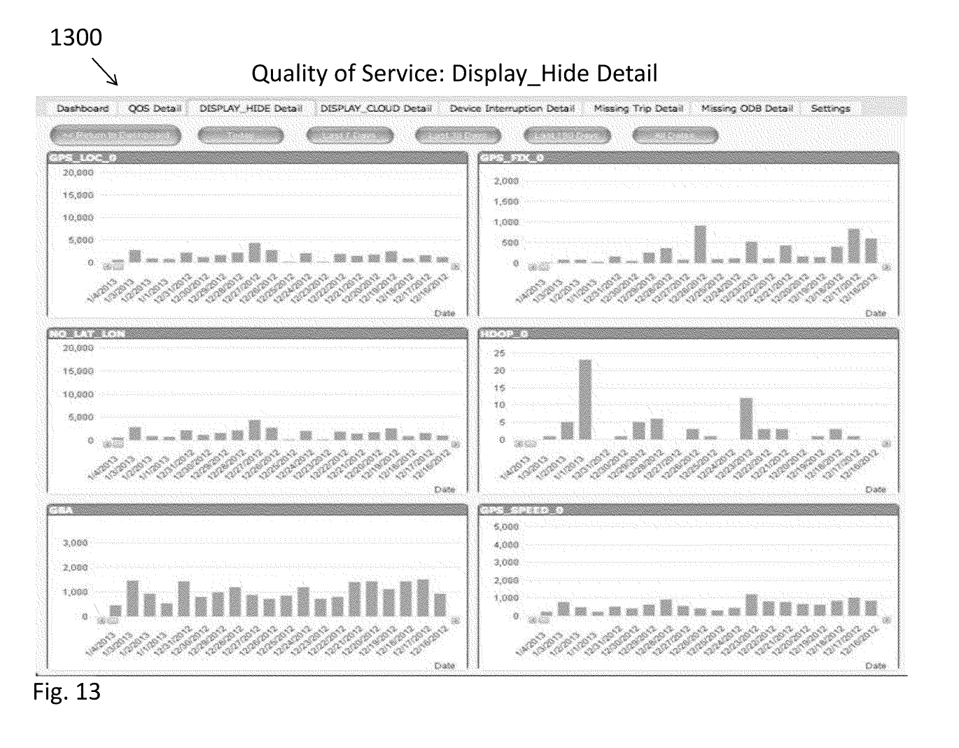

FIG. 13 shows a screenshot 1300 of an exemplary view of Display_Hide detail that shows the instances of data that were deemed unreliable and were not displayed to the user in the customer center 430. The data may still be provided to the carrier center 420, for observation of trends and possible resolution of issues, such as, for example, hardware and/or software issues.

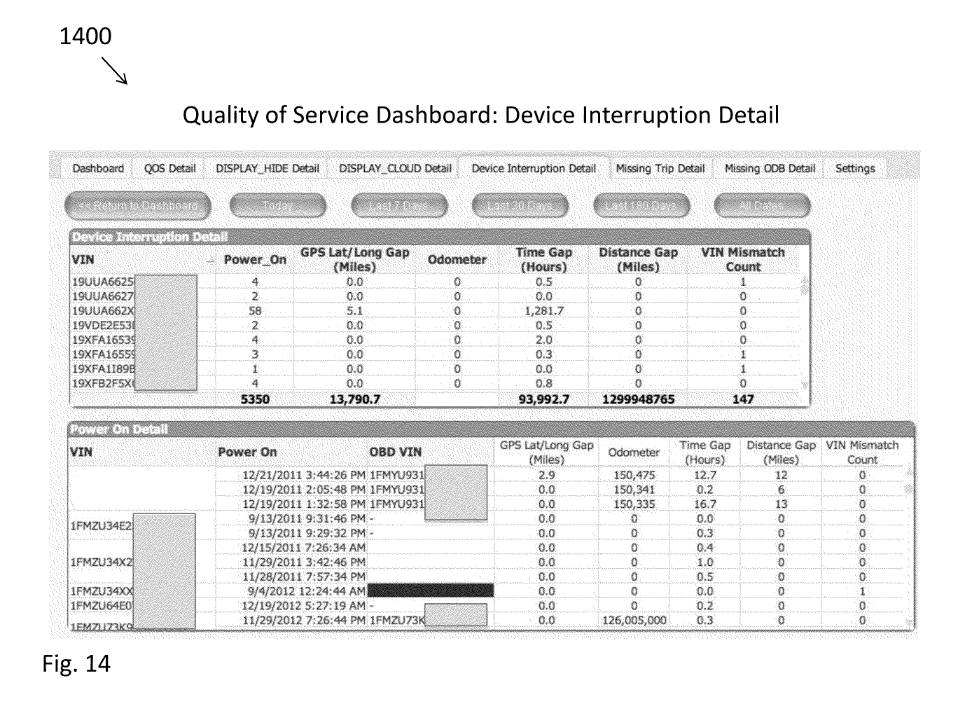

FIG. 14 shows a screenshot 1400 of an exemplary view of the device interruption detail page that can provide vehicle 102 level data, including data, for example, that may be associated with potential device 204 malfunction and/or potential user fraud. In some embodiments, for example, a mismatch between the enrolled VIN and the OBD VIN may be reported at power on.

FIG. 15 shows a screenshot 1500 of an exemplary view of a diagram that plots the number of satellites and the HDOP for two device vendors (data for each vendor are shown with either circles or squares). For example, trends that show outliers (e.g., below 1.0 HDOP and below 7 satellites) can be reported to the individual vendor, which may help identify causes to facilitate improvement.

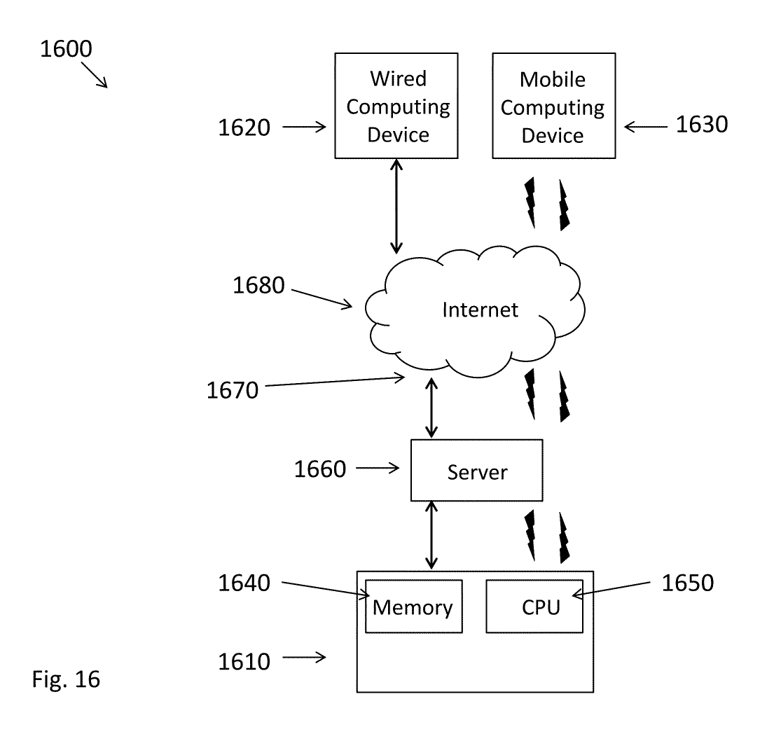

FIG. 16 includes an exemplary depiction of exemplary communication protocols and exemplary devices containing the exemplary QOS engine 210, 310, 410 and/or executing the QOS process 500. The devices can include the means for executing logic associated with the QOS engine 210, 310, 410 and/or the QOS process 500, and their associated applications. The QOS engine 210, 310, 410 and/or QOS process 500 and/or its associated applications may be accessed and/or stored via a variety of computing devices 1610, including, e.g., wired devices 1620 (e.g., desktop computers) and mobile devices 1630 (e.g., smartphones and tablets), kiosks, or any other device capable of hosting or presenting the QOS engine 210, 310, 410 and/or QOS process 500 and/or its associated applications to a user with a display and input mechanism. The QOS engine 210, 310, 410 and/or QOS process 500 and/or its associated applications may be stored in the memory 1640 of a device and processed by a Central Processing Unit (CPU) 1650. The QOS engine 210, 310, 410 and/or QOS process 500 and/or its associated applications may be stored and accessed via the same device, stored remotely in a first device and accessed via a different second device, or any other combination thereof. The QOS engine 210, 310, 410 and/or QOS process 500 and/or its associated applications and/or their associated logic may be stored in local or remote memory (e.g., of a server 1660), and accessible directly or via a network 1670 (e.g., over the internet 1680). The QOS engine 210, 310, 410 and/or QOS process 500 and/or its associated applications may also be a web-based application accessible via the internet 1680. A database, such as, for example, database 214, 314, 414 associated with the QOS engine 210, 310, 410 and/or QOS process 500 and/or its associated applications may be located in the same or different memory location than the QOS engine 210, 310, 410 and/or QOS process 500 and/or its associated applications. Similarly, a database associated with the QOS engine 210, 310, 410 and/or QOS process 500 and/or its associated applications may be accessed the same way or differently than the QOS engine 210, 310, 410 and/or QOS process 500 and/or its associated applications.

While the present invention has been illustrated by the description of embodiments thereof, and while the embodiments have been described in some detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departing from the spirit or scope of the applicant's general inventive concept.

The following is claimed:

1. A method of determining data quality for data associated with driving performance, comprising:
receiving data associated with driving performance;
comparing the data to a quality standard;
determining if the data meets the quality standard; and
selectively reporting the data to at least one data user based on whether the data meets the quality standard.

2. The method of claim 1, further comprising selectively flagging the data based on determining if the data meets the quality standard.

3. The method of claim 2, wherein selectively flagging the data comprises flagging the data that does not meet the quality standard.

4. The method of claim 2, wherein selectively reporting the data to the at least one data user is based on the selective flagging of the data.

5. The method of claim 1, wherein the data is received from a data capturing device associated with a vehicle.

6. The method of claim 1, further comprising converting a data packet associated with a plurality of data readings into data associated with individual data readings.

7. The method of claim 1, further comprising:
grouping individual data readings into a data group;
comparing the data group to a group quality standard;
determining if the data group meets the group quality standard; and
selectively reporting the data group to the at least one data user based on whether the data group meets the group quality standard.

8. The method of claim 1, wherein the quality standard comprises a predetermined threshold associated with a value of a data attribute.

9. The method of claim 1, wherein selectively reporting the data to the at least one data user comprises determining whether to send the data to the at least one data user.

10. The method of claim 9, wherein at least some data is displayed by the at least one data user.

11. The method of claim 1, further comprising storing the data in a database.

12. The method of claim 1, further comprising determining if the data should be retained based on whether the data meets the quality standard.

13. The method of claim 1, further comprising determining if the data should be displayed based on whether the data meets the quality standard.

14. The method of claim 1, further comprising determining if the data should be used for computations associated with rating driving performance based on whether the data meets the quality standard.

15. The method of claim 1, wherein the at least one data user comprises an application associated with a driving performance product.

16. The method of claim 1, wherein the at least one data user comprises at least one of a carrier of a driving performance product, a customer of the driving performance product, a manager of a driving performance product quality of service application, and an actuary for the driving performance product.

17. The method of claim 1, wherein the at least one data user comprises at least one of a data capturing device manufacturer, a vehicle manufacturer, and a software vendor, wherein the software vendor provides software for a data capturing device or a vehicle.

18. The method of claim 1, wherein reporting the data to at least one data user comprises sending the data to a database accessible by the at least one data user.

19. The method of claim 1, wherein reporting the data to at least one data user comprises sending the data to the at least one data user.

20. The method of claim 1, further comprising modifying the quality standard.

21. The method of claim 20, wherein modifying the quality standard is based on the data.

22. The method of claim 20, wherein modifying the quality standard is performed by at least one of a carrier of a driving performance product and a manager of a driving performance product quality of service application.

23. The method of claim 1, wherein selectively reporting the data to the at least one data user comprises reporting data to a plurality of data users, and wherein the data reported to one of the plurality of data users is different than the data reported to another of the plurality of data users.

24. The method of claim 1, wherein displayable data is displayed by the at least one data user based at least in part on whether the data meets the quality standard.

25. The method of claim 24, wherein the at least one data user comprises a plurality of data users, and wherein the data displayed by one of the plurality of data users is different than the data displayed by another of the plurality of data users.

26. The method of claim 1, wherein the quality standard is associated with detecting fraud.

27. A quality of service system for a driving performance product, comprising:
a computer system, comprising a memory and a processor, wherein the memory comprises a quality of service application, and wherein the quality of service application comprises logic for:
receiving data associated with driving performance;
comparing the data to a quality standard;
determining if the data meets the quality standard; and
selectively reporting the data to at least one data user based on whether the data meets the quality standard.

28. A computer readable medium comprising a quality of service application, wherein the quality of service application comprises logic for:
receiving data associated with driving performance;
comparing the data to a quality standard;
determining if the data meets the quality standard; and
selectively reporting the data to at least one data user based on whether the data meets the quality standard.

29. A quality of service system for a driving performance product, comprising:
means for receiving data associated with driving performance;
means for comparing the data to a quality standard;
means for determining if the data meets the quality standard; and
means for selectively reporting the data to at least one data user based on whether the data meets the quality standard.
